(19) United States
(12) Patent Application Publication
(10) Pub. No.: US 2013/0062148 A1
(43) Pub. Date: Mar. 14, 2013

(54) ELECTROMECHANICAL BRAKE MODULE AND ELECTROMECHANICAL BRAKE SYSTEM INCLUDING THE SAME

(71) Applicant: Seung Young PARK, Yongin-si (KR)

(72) Inventor: Seung Young PARK, Yongin-si (KR)

(21) Appl. No.: 13/607,105

(22) Filed: Sep. 7, 2012

(30) Foreign Application Priority Data
Sep. 8, 2011 (KR) 10-2011-0091111

(51) Int. Cl. B60T 1/06; F16D 65/18; F16D 55/22

(52) U.S. Cl. 188/72.1

(57) ABSTRACT

Disclosed is an electromechanical brake system. The electromechanical brake system includes an electric motor, a reduction gear to transfer power of the electric motor, a screw spindle connected to the reduction gear, the screw spindle being rotatably provided, a spindle nut coupled to the screw spindle, the spindle nut being linear-movably provided, a brake pad to move toward the disc, as the spindle nut applies pressure thereto, and a self-locking structure to limit movement of the spindle nut and thereby prevent the spindle nut from being moved in a reverse direction, when the brake pad contacts the disc.

### CROSS-REFERENCE TO RELATED APPLICATION

This application claims the benefit of Korean Patent Application No. P2011-0091111, filed on Sep. 8, 2011, in the Korean Intellectual Property Office, the disclosure of which is incorporated herein by reference.

### BACKGROUND

1. Field

Embodiments of the present invention relate to an electromechanical brake module and an electromechanical brake system including the same. More specifically, embodiments of the present invention relate to an electromechanical brake module having a self-locking property and an electromechanical brake system including the same.

2. Description of the Related Art

A brake is an apparatus for controlling and adjusting a driving speed of vehicles. An electro-hydraulic brake (EHB) is a brake that sends a driving fluid to a wheel cylinder of a wheel and thereby performs braking using a fluid pressure. Also, an electromechanical brake (EMB) is a brake that sends an electrical signal to a caliper of the wheel and drives a motor to perform braking.

In particular, an operation mechanism of the electromechanical brake system is as follows. When a driver works a pedal, a sensor of the pedal detects a brake will. An electronic control unit calculates a vehicle's braking power according to a braking will and transfers a signal to an EMB module mounted on the wheel. According to this signal, a motor is driven and a piston of the caliper goes forward due to the driving force of the motor. The piston pushes a brake pad and a braking power is obtained by a frictional force between the brake pad and a disc. Meanwhile, when the driver works a parking brake, the electronic control unit transports a signal to the EMB module. The subsequent motion is described above.

### SUMMARY

Therefore, it is one aspect of the present invention to provide an improved electromechanical brake module with a self locking property and an electromechanical brake system including the same.

Additional aspects of the invention will be set forth in part in the description which follows and, in part, will be obvious from the description, or may be learned by practice of the invention.

In accordance with one aspect of the present invention, provided is an electromechanical brake system including: an electric motor; a reduction gear to transfer power of the electric motor; a screw spindle connected to the reduction gear, the screw spindle being rotatably provided; a spindle nut coupled to the screw spindle, the spindle nut being linear-movably provided; a brake pad to move toward the disc, as the spindle nut applies pressure thereto; and a self-locking structure to limit movement of the spindle nut and thereby prevent the spindle nut from being moved in a reverse direction, when the brake pad contacts the disc.

The screw spindle may be coupled to the spindle nut in a ball screw manner.

In the self-locking structure, the screw spindle may include a flange, wherein the flange supports one part of the spindle nut, when rotated at a predetermined angle or higher.

The flange may include an extension member that extends toward the spindle nut, and the spindle nut may include a key supported by the extension member of the flange.

The extension member may include a slope having an inclination.

The key may be supported in a lower part of the slope, when the brake pad is slightly worn, and the key may be supported in an upper part of the slope, when the brake pad is seriously worn.

In accordance with another aspect of the present invention, provided is an EMB module of an electromechanical brake including: an electric motor; a reduction gear to transfer power of the electric motor; and a caliper connected to the reduction gear to generate braking power, wherein the caliper includes: a housing; a screw spindle rotatably provided on the housing; a spindle nut coupled to the screw spindle, the spindle nut being linear-movably provided; and a brake pad to move toward the disc, as the spindle nut applies pressure thereto, wherein the screw spindle supports the spindle nut to prevent the spindle nut from being moved in a reverse direction when the brake pad contacts the disc.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a main configuration of an electromechanical brake system according to one embodiment of the present invention;

FIG. 2 is a view illustrating a main configuration of an EMB module according to one embodiment of the present invention;

FIG. 3 is a view illustrating a first position of a self-locking structure according to one embodiment;

FIG. 4 is a view illustrating the first position of the self-locking structure taken along the direction of A-A in FIG. 3;

FIG. 5 is a view illustrating a second position of a self-locking structure according to one embodiment;

FIG. 6 is a view illustrating the second position of the self-locking structure taken along the direction B-B′ in FIG. 5;

FIG. 7 is a view illustrating a third position of an EMB according to one embodiment of the present invention; and

FIG. 8 is a view illustrating the third position of the EMB taken along the direction of C-C′ in FIG. 7.

### DETAILED DESCRIPTION

Hereinafter, an electromechanical brake system according to one embodiment of the present invention will be described with reference to the accompanying drawings.

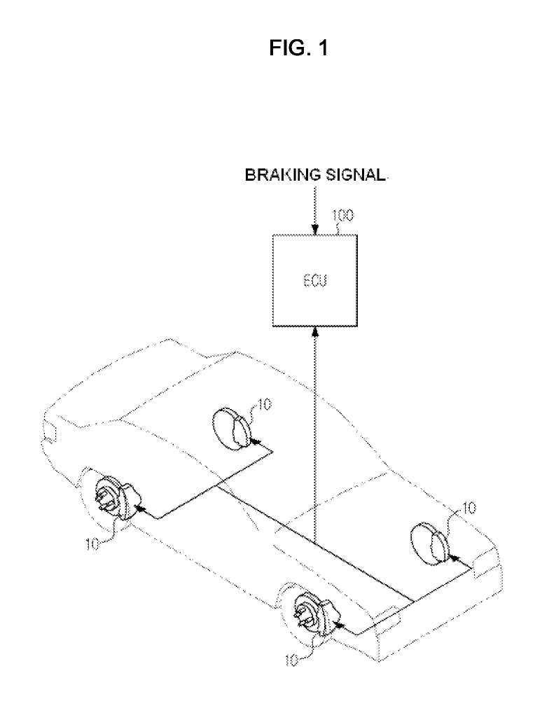

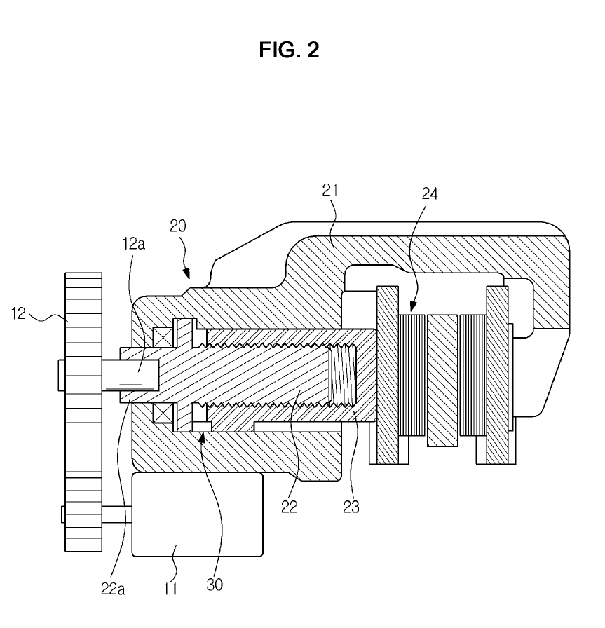

FIG. 1 is a view illustrating a main configuration of an electromechanical brake system according to one embodiment of the present invention. FIG. 2 is a view illustrating a main configuration of an EMB module according to one embodiment of the present invention.

As shown in FIGS. 1 and 2, the electromechanical brake system includes an EMB module 10 and an electronic control unit 100 to control movement of the EMB module 10.

The EMB module 10 includes an electric motor 11, a reduction gear 12 and a caliper 20.

The electric motor 11 receives a signal from the electronic control unit 100 to generate power. A pedal sensor (not shown) detects a braking will of a driver and sends a signal to the electronic control unit 100, and the electronic control unit 100 detects a driver's required braking level and sends a signal to the electric motor 11. The electric motor 11 generates a driving force corresponding to the driver's required braking level. Meanwhile, the electronic control unit 100 detects a parking signal of the driver and sends the signal to the electric motor 11. In this case, the electric motor 11 also generates a brake force corresponding to a brake level required for parking.

The reduction gear 12 is connected to the electric motor 11 to transfer the power. The reduction gear 12 reduces a rate of rotation of the electric motor 11 and increases a torque thereof. The output stage 12a of the reduction gear 12 is connected to the screw spindle 22 of the caliper 20 to transfer rotational force.

The reduction gear 12 may be a single planet gear and a plurality of planet gears may be disposed in parallel in order to increase a reduction rate.

The caliper 20 includes a caliper housing 21, a screw spindle 22, a spindle nut 23, and a brake pad 24.

The screw spindle 22 is rotatably provided on the caliper housing 21. The input stage 22a of the screw spindle 22 is connected to the output terminal 12a of the reduction gear 12 to receive a rotational force.

The spindle nut 23 is linear-movably provided on the caliper housing 21. The spindle nut 23 may be coupled to the screw spindle 22 in a ball screw manner. That is, the ball screw manner has a configuration in which a steel ball may be inserted between the screw groove of the screw spindle 22 and the screw groove of the spindle nut 23. Such a ball screw-type coupling configuration may convert rotational movement of the screw spindle 22 into linear movement of the spindle nut 23.

The ball screw-type coupling configuration has a high power conversion efficiency, thus making self-locking of the spindle nut 23 difficult. That is, during brake operation, the spindle nut 23 is returned to the original position and brake operation may be removed. This phenomenon may occur in cases of ball screw-type coupling as well as general coupling between the screw spindle and the spindle nut. Accordingly, a self-locking structure 30 may be provided between the screw spindle 22 and the spindle nut 23 in order to realize self-locking of the spindle nut 23 during the brake operation.

The brake pad 24 includes a plate 25 and a pad 26. The spindle nut 23 moves the plate 25 toward a disc 40, and the pad 26 contacts the disc 40 to generate a braking power.

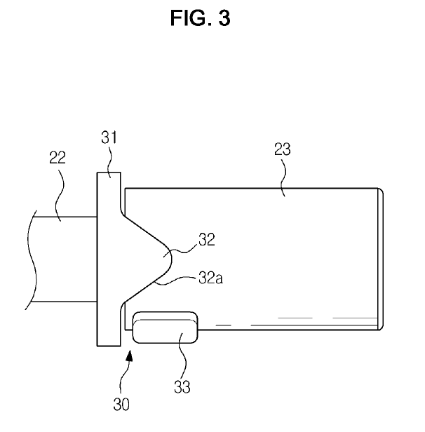

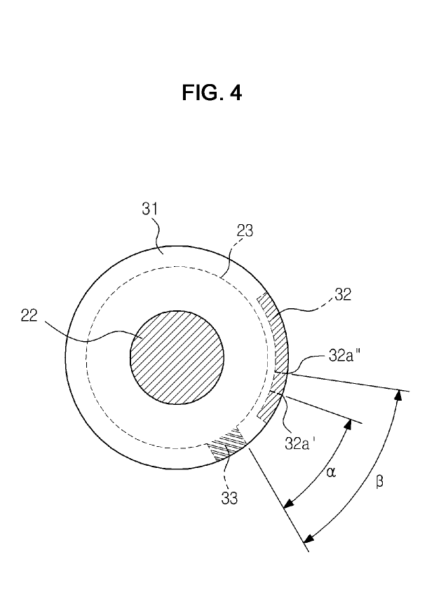

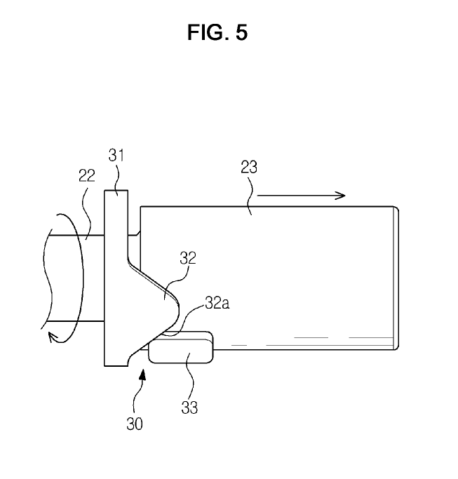

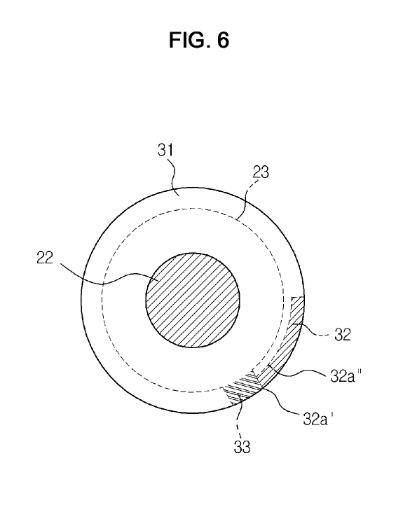

FIG. 3 is a view illustrating a first position of a self-locking structure according to one embodiment, FIG. 4 is a view illustrating the first position of the self-locking structure taken along the direction A-A in FIG. 3, FIG. 5 is a view illustrating a second position of a self-locking structure according to one embodiment, and FIG. 6 is a view illustrating a second position of the self-locking structure taken along the direction of B-B′ in FIG. 5.

As shown in FIGS. 2 to 6, the self-locking structure 30 includes an extension member 32 provided in a flange of the screw spindle 22 and a key 33 provided in the spindle nut 23.

The extension member 32 protrudes and extends toward the spindle nut 23 from the flange 31. The extension member 32 includes at least one slope 32a.

The key 33 protrudes on the outer surface of the spindle nut 23. The key 33 is for example a guide protrusion, guiding the spindle nut 23 to linearly reciprocate in a bore 21a of the caliper housing 21.

The key 33 may be supported by a slope 32a. For example, when the brake pad 24 is thick, the key 33 may be supported in a lower part of the slope 32a, and when the brake pad 24 is worn and becomes thin, the key 33 may be supported in an upper part of the slope 32a. Here, the lower part of the slope 32a is referred to as a “first support point” 32a′ and the upper part thereof is referred to as a “second support point” 32a″.

Hereinafter, operation of the electromechanical brake system will be described in detail.

When a driver puts on a brake pedal during driving, the electronic control unit 100 detects the demanded braking level of the deriver, based on a pedal sensor (not shown) signal, and drives the electric motor 11 to generate a driving force corresponding thereto.

Next, the driving force of the electric motor 11 is transferred through the reduction gear 12 to the screw spindle 22. Accordingly, as the screw spindle 22 rotates, the spindle nut 23 linearly moves. The spindle nut 23 applies a pressure to the plate 25 to bring the pad 26 in contact with the disc 40. A braking power is generated by a frictional force between the pad 26 and the disc 40.

Next, when the driver takes their feet off the brake pedal, the electronic control unit 100 detects a brake removal signal, based on the pedal sensor signal, and drives the electric motor 11 in an opposite direction.

Next, the driving force of the electric motor 11 is transferred through the reduction gear 12 to the screw spindle 22, the screw spindle 22 rotates in an opposite direction and the spindle nut 23 returns to the original position. At this time, the brake pad 24 is also spaced from the disc 40 and the braking power disappears.

Also, when the driver wants to park a vehicle, the electronic control unit 100 receives a parking signal to drive the electric motor 11.

Next, the driving force of the electric motor 11 is transferred through the reduction gear 12 to the screw spindle 22. As the screw spindle 22 rotates at a predetermined angle (α), the spindle nut 23 linearly moves. The spindle nut 23 applies pressure to the plate 25 to bring the pad 26 in contact with the disc 40. A braking power is generated by a frictional force between the pad 26 and the disc 40. This braking power generates a repulsion force in the brake pad 24. This repulsion force is also transferred to the spindle nut 23 to have the spindle nut 23 move in an opposite direction. However, during a braking operation, as the screw spindle 22 rotates at a predetermined angle (α), the extension member 32 also rotates at a predetermined angle (α). At this time, the key 33 of the spindle nut 23 is supported by the first support point 32a′ that is disposed below the slope 32a of the extension member 32 to prevent the spindle nut 23 from returning to the original position. As a result, although power supply is ceased, the brake pad 24 still contacts the disc 40 and the braking power is thus maintained.

Next, when power is supplied again, the electronic control unit 100 drives the electric motor 11 in an opposite direction to rotate the screw spindle 22 in an opposite direction and separate the extension member 32 from the key 33. At this time, the spindle nut 23 returns to the original position again, the brake pad 24 is separated from the disc 40, and the braking power disappears.

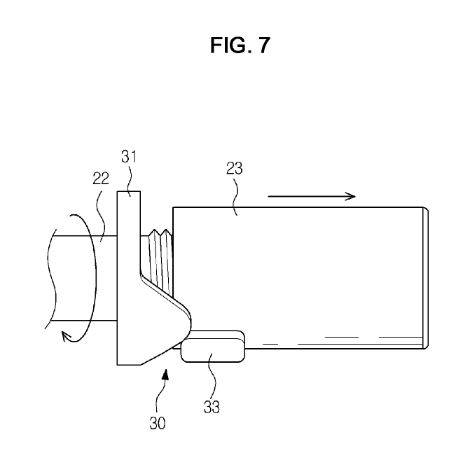

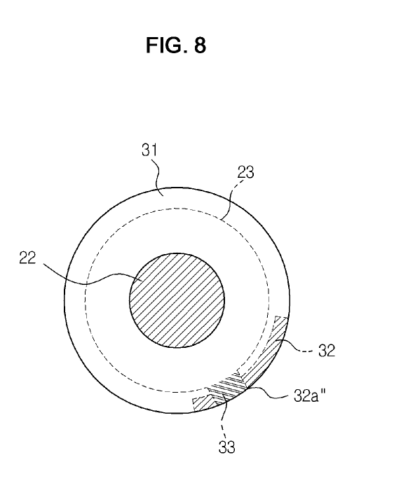

FIG. 7 is a view illustrating a third position of EMB according to one embodiment of the present invention. FIG. 8 is a view illustrating the third position of the EMB taken along direction of C-C′ in FIG. 7.

As shown in FIGS. 7 and 8, when the pad 26 becomes thin, in order to generate braking power, the screw spindle 22 should rotate at an angle (β) higher than a predetermined angle (α). At this time, the extension member 32 also rotates at an angle (β) higher than a predetermined angle (α). At this time, the key 33 is supported by the second support point 32a″ that is disposed in an upper part of the slope 32a of the extension member 32 to realize self-locking of the spindle nut 23. As a result, the self-locking structure 30 is continuously reusable although the brake pad 24 is worn.

The electromechanical brake system according to embodiments of the present invention reduces the volume of the EMB module and thereby improves mounting properties.

Also, the electromechanical brake system advantageously has superior assembly properties due to the self-locking structure.

Also, the electromechanical brake system advantageously exhibits improved durability and heat resistance since it is capable of performing self-locking even in the absence of power supply.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electromechanical brake system comprising:
an electric motor;
a reduction gear to transfer power of the electric motor;
a screw spindle connected to the reduction gear, the screw spindle being rotatably provided;
a spindle nut coupled to the screw spindle, the spindle nut being linear-movably provided;
a brake pad to move toward the disc, as the spindle nut applies pressure thereto; and
a self-locking structure to limit movement of the spindle nut and thereby prevent the spindle nut from being moved in a reverse direction, when the brake pad contacts the disc.

2. The electromechanical brake system according to claim 1, wherein the screw spindle is coupled to the spindle nut in a ball screw manner.

3. The electromechanical brake system according to claim 1, wherein, in the self-locking structure, the screw spindle comprises a flange,
wherein the flange supports one part of the spindle nut, when rotated at a predetermined angle or higher.

4. The electromechanical brake system according to claim 3, wherein the flange comprises an extension member that extends toward the spindle nut, and
the spindle nut comprises a key supported by the extension member of the flange.

5. The electromechanical brake system according to claim 4, wherein the extension member comprises a slope having an inclination.

6. The electromechanical brake system according to claim 5, wherein the key is supported in a lower part of the slope, when the brake pad is slightly worn, and
the key is supported in an upper part of the slope, when the brake pad is seriously worn.

7. An EMB module of an electromechanical brake comprising:
an electric motor;
a reduction gear to transfer power of the electric motor; and
a caliper connected to the reduction gear to generate braking power,
wherein the caliper comprises:
a housing;
a screw spindle rotatably provided on the housing;
a spindle nut coupled to the screw spindle, the spindle nut being linear-movably provided; and
a brake pad to move toward the disc, as the spindle nut applies pressure thereto,
wherein the screw spindle supports the spindle nut to prevent the spindle nut from being moved in a reverse direction when the brake pad contacts the disc.
